(19) United States
(12) Patent Application Publication
(10) Pub. No.: US 2010/0272016 A1
(43) Pub. Date: Oct. 28, 2010

(54) METHOD FOR SUPPORTING TRANSPORT NETWORK INDEPENDENT IP MOBILITY IN MOBILE TERMINAL AND SYSTEM THEREOF

(76) Inventors: Nam Seok Ko, Daejeon (KR); Ho Yong Ryu, Daejeon (KR); Sung Back Hong, Daejeon (KR); Young Beom Choi, Choongchungnam-do (KR); Kyeong Ho Lee, Daejeon (KR); Kyung Pyo Jun, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/747,729

(22) PCT Filed: Dec. 4, 2008
(86) PCT No.: PCT/KR08/07188

§ 371 Date: Jun. 11, 2010

(30) Foreign Application Priority Data
Dec. 12, 2007 (KR) 10-2007-0129477

(51) Int. Cl. H04W 40/00

(52) U.S. Cl. 370/328

(57) ABSTRACT

A method and system for supporting Internet protocol (IP) mobility independently of the IP version of a transport network are provided. The method includes providing a mobility control apparatus, which maps the home addresses of a plurality of mobile terminals, including first and second mobile terminals, and the Care-of-Addresses (CoAs) of the mobile terminals, and setting a first control tunnel between the mobility control apparatus and the first mobile terminal, the care-of-addresses varying from one transport network to another transport network; setting a second control tunnel between the mobility control apparatus and the second mobile terminal; and enabling the first and second mobile terminals to exchange a data packet with each other through the first and second control tunnels.

### TECHNICAL FIELD

The present invention relates to a method and system for supporting Internet protocol (IP) mobility, and more particularly, to a method and system for supporting IP mobility for a mobile terminal equipped with multiple interfaces regardless of the IP version of a transport network.

The present invention was supported by the IT R&D program of Ministry of Information and Communication (MIC) and Institute for Information Technology Advancement (IITA) [Project No.: 2007-S-013-01, Project Title: Development of All IPv6-Based Fixed-Mobile Convergence Networking Technology]

### BACKGROUND ART

Various methods of supporting Internet protocol (IP) mobility in a network layer such as Mobile IPv4 and Mobile IPv6 have been standardized by the Internet Engineering Task Force (IETF), and the development of various algorithms for minimizing handover delays such as Fast Mobile IPv4 are under way.

Conventional methods of supporting IP mobility require a number of functions to be added to existing transport network equipment such as routers and thus may not be suitable for use in existing transport networks. Therefore, it is necessary to develop methods capable of easily supporting the mobility of mobile terminals in an existing transport network simply by additionally providing a mobility control apparatus for upgrading software programs present in mobile terminals and for controlling the mobility of mobile terminals to an existing transport network without a requirement of the addition of new functions to existing transport equipment such as routers.

### DISCLOSURE

### Technical Problem

The present invention provides a method and system for supporting Internet protocol (IP) mobility for a mobile terminal equipped with multiple interfaces regardless of the IP version of a transport network.

### Technical Solution

According to an aspect of the present invention, there is provided a method of supporting Internet protocol (IP) mobility, the method including providing a mobility control apparatus, which maps the home addresses of a plurality of mobile terminals, including first and second mobile terminals, and the Care-of-Addresses (CoAs) of the mobile terminals, and setting a first control tunnel between the mobility control apparatus and the first mobile terminal, the care-of-addresses varying from one transport network to another transport network; setting a second control tunnel between the mobility control apparatus and the second mobile terminal; and enabling the first and second mobile terminals to exchange a data packet with each other through the first and second control tunnels.

According to another aspect of the present invention, there is provided a system for supporting IP mobility, the apparatus including a mobility control apparatus configured to map the home addresses of a plurality of mobile terminals and the CoAs of the mobile terminals; a first mobile terminal configured to set a first control tunnel between the first mobile terminal and the mobility control apparatus; and a second mobile terminal configured to set a second control tunnel between the second mobile terminal and the mobility control apparatus, wherein the first and second mobile terminals exchange a data packet with each other through the first and second control tunnels.

According to another aspect of the present invention, there is provided a computer-readable recording medium having recorded thereon a computer program for executing a method of supporting IP mobility, the method including providing a mobility control apparatus, which maps the home addresses of a plurality of mobile terminals, including first and second mobile terminals, and the CoAs of the mobile terminals, and setting a first control tunnel between the mobility control apparatus and the first mobile terminal, the care-of-addresses varying from one transport network to another transport network; setting a second control tunnel between the mobility control apparatus and the second mobile terminal; and enabling the first and second mobile terminals to exchange a data packet with each other through the first and second control tunnels.

### ADVANTAGEOUS EFFECTS

According to the present invention, it is possible to support IPv4 or IPv6 application services for mobile terminals equipped with multiple interfaces regardless of an IP version supported by a transport network, and to support mobility for such application services without discontinuity. In addition, according to the present invention, it is possible to support mobility even in existing transport networks simply by upgrading software programs present in mobile terminals and introducing a mobility control apparatus without the need to add additional functions to conventional transport network equipment.

### DESCRIPTION OF DRAWINGS

FIG. 1 illustrates a diagram for explaining the setting of control tunnels between a mobile terminal and a mobility control apparatus, as performed in a method of supporting Internet protocol (IP) mobility according to an embodiment of the present invention;

FIG. 2 illustrates a flowchart of the setting of control tunnels between a mobile terminal and a mobility control apparatus, as performed in the method of supporting Internet protocol (IP) mobility;

FIG. 3 illustrates an FIBv6 table and an FIBv4 table;

FIG. 4 illustrates a diagram for explaining the exchange of messages and data between mobile terminals, as performed in the method of supporting IP mobility;

FIG. 5 illustrates a diagram for explaining the exchange of a data packet between mobile terminals through a direct data channel, as performed in the method of supporting IP mobility;

FIG. 6 illustrates a flowchart for further explaining the exchange of a data packet between mobile terminals through a direct data channel, as performed in the method of supporting IP mobility; and

FIG. 7 illustrates a flowchart of a handover operation, as performed in the method of supporting IP mobility.

### BEST MODE

The present invention will hereinafter be described more fully with reference to the accompanying drawings, in which exemplary embodiments of the invention are shown.

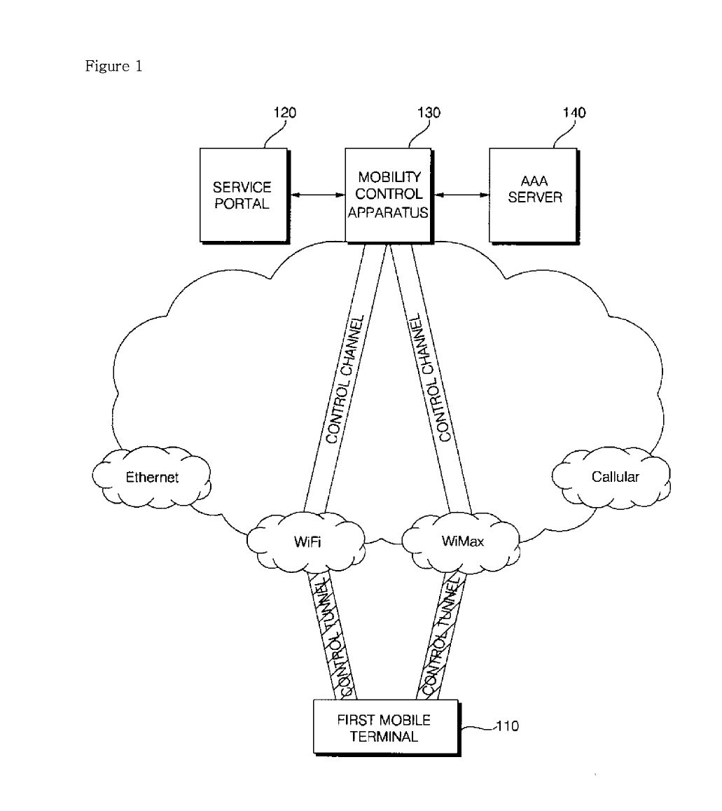

FIG. 1 illustrates a diagram for explaining the setting of control tunnels between a mobile terminal and a mobility control apparatus, as performed in a method of supporting Internet protocol (IP) mobility according to an embodiment of the present invention. Referring to FIG. 1, two control tunnels are set between a first mobile terminal 110 and a mobility control apparatus 130, and the mobility control apparatus 130 is connected to a service portal 120 and an Authentication-Authorization-Accounting (AAA) server 140 so as to be able to communicate with the service portal 120 and the AAA server 140.

The mobility control apparatus 130 sets control channels to the first mobile terminal 110, and manages the mapping relationship between a home address of the first mobile terminal 110 and a Care-of-Address (CoA) of the first mobile terminal, which is determined according to a current position of the first mobile terminal and varies from one interface to another interface of the first mobile terminal 110. The home address of the first mobile terminal 110 may serve the functions of a user identifier. Since the control channels are created using a tunneling method so as to be able to be driven independently of a transport network, the control channels may become control tunnels. In order to transmit a packet through a control tunnel, a CoA of an interface set according to the IP version of a transport network to be used may be used as an external tunnel header of the packet, and a home address of an interface set according to the IP version of a user application to be used by the first mobile terminal 110 may be used as an internal tunnel header of the packet.

A mobile terminal such as the first mobile terminal 110 may be provided with a home address, which is a unique address that never changes regardless of the position of the mobile terminal or the number of interfaces supported by the mobile terminal, and a CoA, which may vary according to the type of interface currently being used and the position of the mobile terminal.

Therefore, a mobile terminal may have only one home address and more than one CoA. A home address may be allocated to a mobile terminal according to the IP version of an application to be used, and a CoA may be allocated to a mobile terminal according to the IP version of a transport network. Therefore, in the case of using an IPv6 application in an IPv4 network, a mobile terminal may be provided with an IPv6 home address and an IPv4 CoA.

In principle, a mobile terminal may be provided with only one home address. However, in order to use a plurality of applications having different IP versions at the same time, a mobile terminal may be provided with a plurality of home addresses having different IP versions. For example, a mobile terminal may be provided with an IPv4 home address for using an IPv4 application and an IPv6 home address for using an IPv6 application. However, assume that a mobile terminal generally has only one home address.

The first mobile terminal 110 includes multiple interfaces, and thus, a control tunnel may be set separately for each of the multiple interfaces. One of the multiple interfaces may be chosen according to a set of rules such as user preference or signal strength. In this case, the chosen interface is referred to as a primary interface. A primary control tunnel may be set through a primary interface. The first mobile terminal 110 may transmit/receive a control message or user data through a primary control tunnel.

An interface of a mobile terminal that is not chosen as a primary interface may be used as a secondary interface in case a primary interface malfunctions. A secondary control tunnel may be set through a secondary interface.

It may be determined when to set a secondary control tunnel according to user preference or the importance of an application currently being used. That is, a secondary control tunnel may be automatically set when a primary control tunnel is set. Alternatively, a secondary control tunnel may be set through user setting. A setting tool of the first mobile terminal 110 may enable a secondary control tunnel to be set either through default setting or through user setting.

In order to maintain a secondary control tunnel, a keep-alive message may be continuously transmitted so that the secondary control tunnel can stay in standby mode. If primary and secondary control tunnels are set at the same time and the primary control tunnel is determined to malfunction due to problems of a primary interface, a secondary interface may replace the primary interface, and the secondary control tunnel may replace the primary control tunnel.

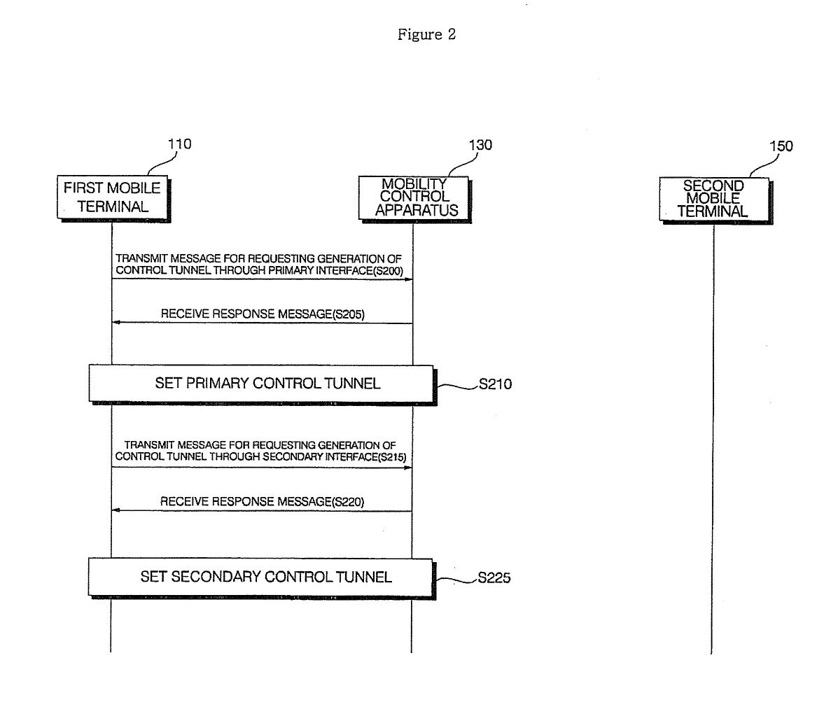

FIG. 2 illustrates a flowchart of the setting of a control tunnel. The setting of a control tunnel may be performed by the exchange of a typical request message and a response message.

Referring to FIG. 2, the first mobile terminal 110 transmits a first control tunnel creation request message to the mobility control apparatus 130 through a primary interface of the first mobile terminal 110 (S200). Thereafter, the first mobile terminal 110 receives a response message corresponding to the first control tunnel creation request message from the mobility control apparatus 130 (S205). As a result, a primary control tunnel is established between the first mobile terminal 110 and the mobility control apparatus 130 (S210).

Likewise, the first mobile terminal 110 transmits a second control tunnel creation request message to the mobility control apparatus 130 through a secondary interface of the first mobile terminal 110 (S215). Thereafter, the first mobile terminal 110 receives a response message corresponding to the second control tunnel creation request message from the mobility control apparatus 130 (S220). As a result, a secondary control tunnel is established between the first mobile terminal 110 and the mobility control apparatus 130 (S225).

A request message and a response message may be realized in various manners. Network address translation (NAT) equipment may be used between mobile terminals. Thus, various NAT detection methods may be used for determining whether NAT equipment has been used and what type of NAT equipment has been used.

Even though FIG. 2 only illustrates the setting of primary and secondary control tunnels between the first mobile terminal 110 and the mobility control apparatus 130, it is obvious that primary and secondary control tunnels can be established between the second mobile terminal 150 and the mobility control apparatus 130 using the same method used to establish primary and secondary control tunnels between the first mobile terminal 110 and the mobility control apparatus 130.

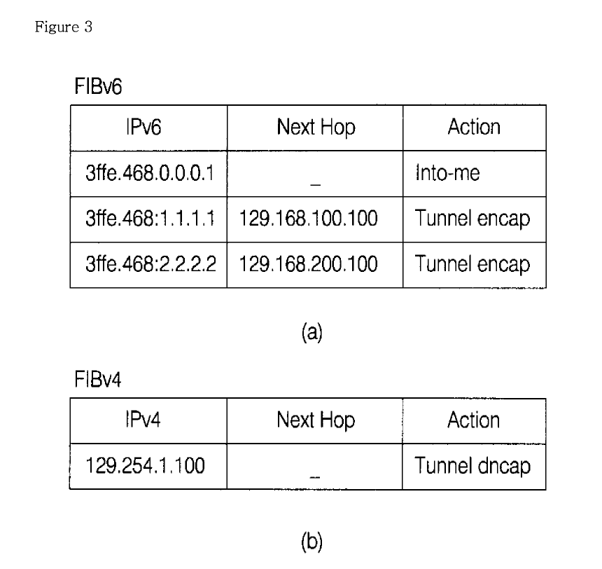

The mobility control apparatus 130 may create an forwarding information base table version 6 (FIBv6) table and an FIBv4 table after the setting of primary and secondary control tunnels to each of the first and second mobile terminals 110 and 150, as illustrated in FIG. 2. The FIBv6 table and the FIBv4 table are illustrated in FIG. 3. Referring to FIG. 3, the FIBv6 table and the FIBv4 table are created after primary and secondary control tunnels are established between the first mobile terminal 110 and the mobility control apparatus 130 and between the second mobile terminal 150 and the mobility control apparatus 130, as illustrated in FIG. 2. The IPv6 home address of the first mobile terminal 110 is 3ffe:468:1.1.1.1, and the CoA of the first mobile terminal 110 is 129.168.100.100. The IPv6 home address of the mobility control apparatus 130 is 3ffe:468::1, and the tunnel end point address of the mobility control apparatus 130 is 129.254.1.100. The FIBv6 table and the FIBv4 table may be realized in various manners, other than that set forth herein.

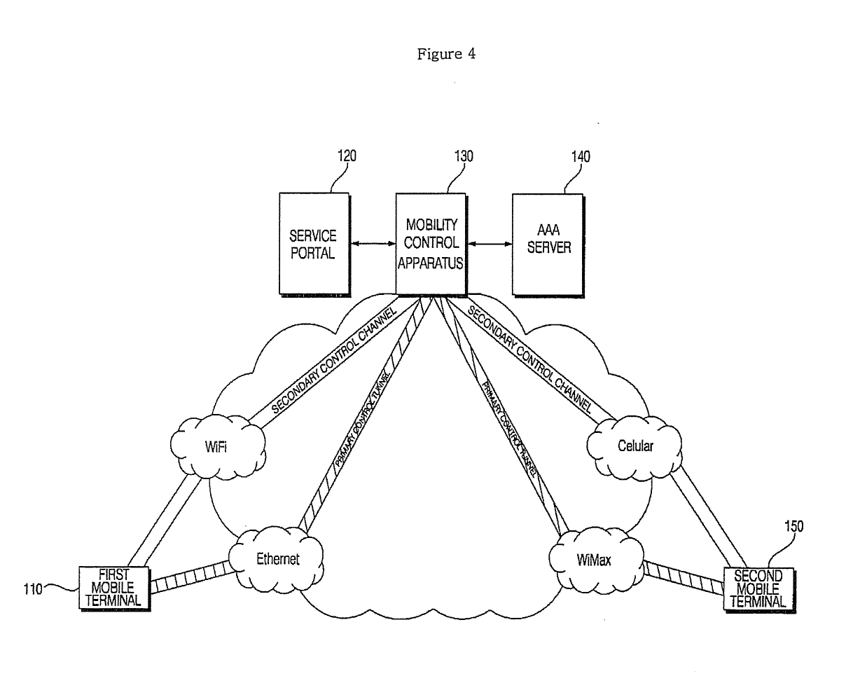

FIG. 4 illustrates a schematic diagram for explaining the exchange of messages and data between the first and second mobile terminals 110 and 150 through primary control channels, as performed in the method of supporting IP mobility. Referring to FIG. 4, according to user configuration, secondary control channels may be activated or not. If the secondary control channel is activated, a keep-alive message may be transmitted through the secondary control channels. Alternatively, the secondary control channels may remain inactive. Control messages may be transmitted from the first and second mobile terminals 110 and 150 to the mobility control apparatus 130 and between the first and second mobile terminals 110 and 150. Data packets may be transmitted between the first and second mobile terminals 110 and 150.

The mobility control apparatus 130 transmits a packet transmitted by an arbitrary mobile terminal to a mobile terminal for which the packet is destined regardless of the type of the packet.

The transmission of a packet may be performed with reference to the FIBv4 table and the FIBv6 table of FIG. 3. The tunnel endpoint address of the mobility control apparatus 130 is set as the destination of a tunnel packet transmitted to the mobility control apparatus 130 and IPv4 CoA of each mobile terminal is set as the destination of the tunnel packet transmitted to the mobility control apparatus 130.

Therefore, if the mobility control apparatus 130 searches the FIBv4 table of FIG. 3 for the destination of an input packet, an identified action field may indicate that tunnel decapsulation needs to be performed, as indicated by the FIBv4 table of FIG. 3. The input packet may be converted into an IPv6 packet through tunnel decapsulation, and thus, the mobility control apparatus 130 may search through the FIBv6 table of FIG. 3. As a result, an action field indicating that tunnel encapsulation needs to be performed may be detected along with an IPv4 address, i.e., the CoA of a mobile terminal. Then, the IPv6 packet may be encapsulated into an IPv4 packet, and the IPv4 packet may be transmitted to the mobile terminal.

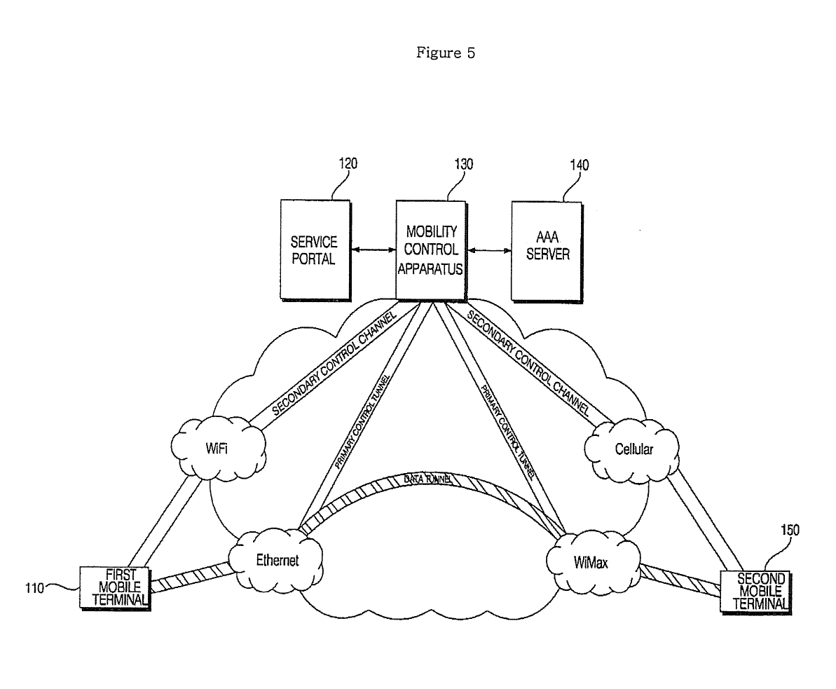

FIG. 5 illustrates a schematic diagram for explaining the exchange of a data packet by setting a tunnel between first and second mobile terminals 110 and 150 with the use of a primary interface, which is used to set a primary control tunnel, as performed in the method of supporting IP mobility.

Referring to FIG. 5, a control tunnel may be used in order for the first and second mobile terminals 110 and 150 to communicate with each other. However, the exchange of data through a primary control tunnel involves performing packet forwarding through the mobility control apparatus 130 and thus results in the use of a long path. In addition, if the first and second mobile terminals 110 and 150 both use a control channel to transmit data packets, the mobility control apparatus 130 may serve as a traffic bottleneck.

Therefore, the first and second mobile terminals 110 and 150 may establish a data channel therebetween and transmit/receive data to/from each other through the data channel. A data channel may be established using the same tunneling method used to create a control channel and may thus be able to operate independently of a transport network. The CoA of an interface set according to the IP version of a transport network is used as an external tunnel header, and the home address of an interface set according to an IP version to be used by the first and second mobile terminals 110 and 150 may be used as an internal tunnel header.

In order for the first and second mobile terminals 110 and 150 to transmit data to each other, address information of the first and second mobile terminals 110 and 150 is required. The address information of the first and second mobile terminals 110 and 150 may be acquired from the mobility control apparatus 130. That is, the first and second mobile terminals 110 and 150 may acquire each other's CoA from the mobility control apparatus 130 by issuing a query to the mobility control apparatus 130. Then, the first and second mobile terminals 110 and 150 establish a data tunnel therebetween using the home addresses and the CoAs of the first and second mobile terminals 110 and 150. In short, in the embodiment of FIG. 5, a data tunnel is set between the first and second mobile terminals 110 and 150, and data packets are directly transmitted between the first and second mobile terminals 110 and 150 through the data tunnel without the mediation of the mobility control apparatus 130.

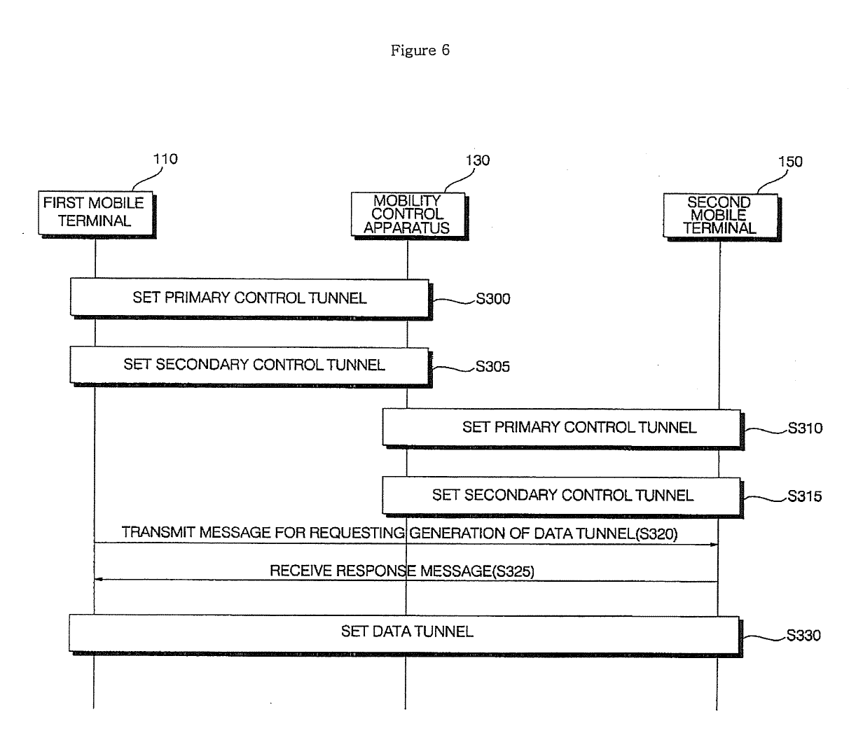

FIG. 6 illustrates a flowchart for further explaining the embodiment of FIG. 5. Referring to FIG. 6, primary and secondary control channels are set between the first terminal 110 and the mobility control apparatus 130 (S300 and S305). Thereafter, primary and secondary control channels are set between the second terminal 150 and the mobility control apparatus 130 (S310 and S315).

Thereafter, the first mobile terminal 110 transmits a message for requesting the setting of a data channel to the second mobile terminal 150 through the primary control tunnel set between the first mobile terminal 110 and the mobility control apparatus 130 (S320). Thereafter, the first mobile terminal 110 receives a response message from the second mobile terminal 150 (S325). Thereafter, a data tunnel is set between the first and second mobile terminals 110 and 150 (S330).

During the setting of a data tunnel between the first and second mobile terminals 110 and 150, security setting processes may be performed using various security methods.

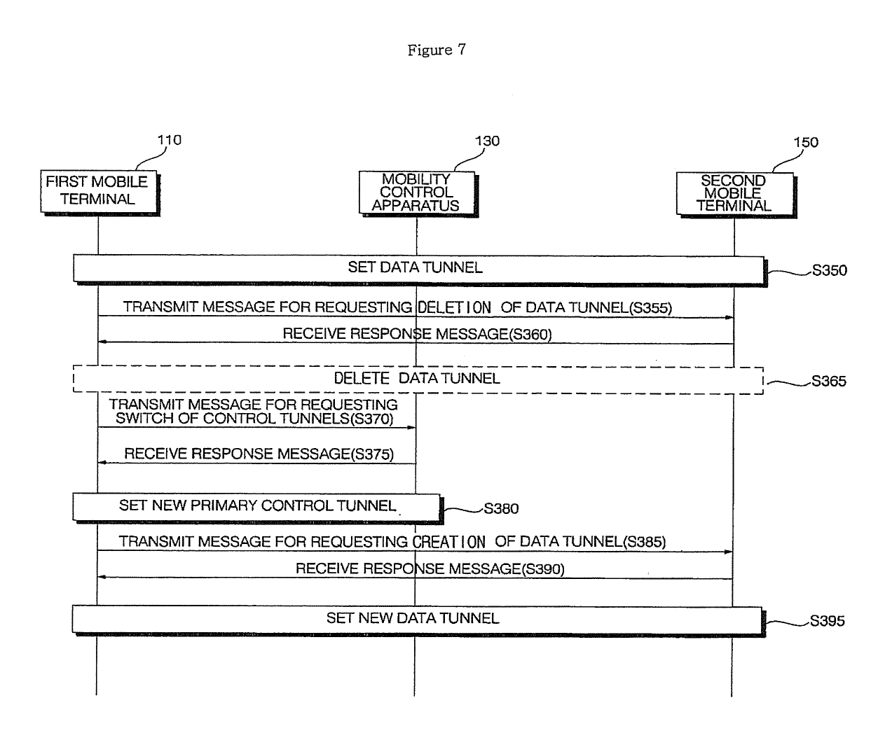

FIG. 7 illustrates a flowchart of a handover operation, as performed in the method of supporting IP mobility. Referring to FIG. 7, if the primary interfaces of the first mobile terminals 110 cannot be used any longer due to the movement of the first d mobile terminal 110 or changes in the circumstances of a network and thus the first and second mobile terminals 110 and 150 are required to communicate with each other with the use of new primary interfaces of the first mobile terminal 110 when both of primary and secondary control channels are set between the first mobile terminal 110 and the mobility control apparatus 130 and a direct data channel is set between the first and second mobile terminals 110 and 150, a handover operation, which can reduce the probability of packet loss, may be performed.

More specifically, referring to FIG. 7, a direct data tunnel is set between the first and second mobile terminals 110 and 150 (S350). Thereafter, the first mobile terminal 110 transmits a message for requesting the deletion of the data tunnel to the second mobile terminal 150 (S355) and requests the second mobile terminal 150 to terminate the transmission of a packet through the data tunnel and to transmit a packet using a control tunnel. Thereafter, the first mobile terminal 110 receives a response message from the second mobile terminal 150 (S360), and then, the data tunnel is deleted (S365).

Thereafter, the first mobile terminal 110 transmits a message for requesting the switchover of control tunnels to the mobility control apparatus 130 (S370). Thereafter, the first mobile terminal 110 receives a response message from the mobility control apparatus 130 (S375). Then, a secondary control tunnel set between the first mobile terminal 110 and the mobility control apparatus 130 becomes a new primary control tunnel (S380).

The first mobile terminal 110 transmits a message for requesting the creation of a data tunnel to the second mobile terminal 150 (S385). Thereafter, the first mobile terminal 110 receives a response message from the second mobile terminal 150 (S390). Then, a new data tunnel is established between the first and second mobile terminals 110 and 150. Thereafter, the first and second mobile terminals 110 and 150 exchange data packets with each other through the new data channel.

In this manner, when the primary interface of a mobile terminal malfunctions due to the movement of the mobile terminal or changes in the circumstances of a network, the secondary interface of the mobile terminal is set as a new primary interface, thereby continuously maintaining the session of an application currently being executed. In this case, since the home address of the mobile terminal never changes, a session may be continuously maintained in a network layer. In addition, since the secondary control tunnel is set between the mobile terminal and a mobility control apparatus before the deletion of the primary control tunnel, it is possible to prevent the occurrence of packet loss and minimize the amount of time for which the provision of a service is terminated.

The present invention has been described above, taking as an example a procedure of providing an IPv6 application service in an IPv4 network. However, the present invention can also be applied to the provision of an IPv4 service in an IPv4 network and the provision of an IPv4 service in an IPv6 network.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention can be applied to a mobile terminal equipped with multiple interfaces, thereby supporting Internet protocol (IP) mobility independently of a transport network.

1. A method of supporting Internet protocol (IP) mobility, the method comprising:
setting a first control tunnel towards a mobility control apparatus which maps the home addresses of a plurality of mobile terminals and the Care-of-Addresses (CoAs) of the mobile terminals;
setting a second control tunnel between the mobility control apparatus and a second mobile terminal; and
exchanging a data packet with the second mobile terminal through the first and second control tunnels.

2. The method of claim 1, wherein the data packet comprises an external tunnel header corresponding to an IP version of a transport network, and an internal tunnel header corresponding to an IP version of a user application.

3. The method of claim 1, wherein the first control tunnel comprises:
a first primary control tunnel set through a primary interface of a first mobile terminal; and
a first secondary control tunnel set through a secondary interface of the first mobile terminal.

4. The method of claim 3, wherein the second control tunnel comprises:
a second primary control tunnel set through a primary interface of the second mobile terminal; and
a second secondary control tunnel set through a secondary interface of the second mobile terminal.

5. The method of claim 4, wherein the primary interface and the secondary interface of each of the first and second mobile terminals are determined based on at least one of user preference and signal strength.

6. The method of claim 5, further comprising:
enabling the first and second mobile terminals to acquire each other's CoA from the mobility control apparatus, setting a data tunnel between the first and second mobile terminals using the acquired CoAs, and enabling the first and second mobile terminals to exchange a data packet with each other through the data tunnel.

7. The method of claim 6, further comprising:
deleting the data tunnel, and enabling a data packet currently being transmitted through the data tunnel to be transmitted through the first and second control tunnels.

8. The method of claim 7, further comprising:
setting a new data tunnel between the first and second mobile terminals, and enabling the first and second mobile terminals to exchange a data packet with each other through the new data tunnel.

9. A system for supporting IP mobility, the apparatus comprising:
a mobility control apparatus configured to map the home addresses of a plurality of mobile terminals and the Care-of-Addresses (CoAs) of the mobile terminals;
a first mobile terminal configured to set a first control tunnel between the first mobile terminal and the mobility control apparatus; and
a second mobile terminal configured to set a second control tunnel between the second mobile terminal and the mobility control apparatus,
wherein the first and second mobile terminals exchange a data packet with each other through the first and second control tunnels.

10. The system of claim 9, wherein the data packet comprises an external tunnel header corresponding to an IP version of a transport network, and an internal tunnel header corresponding to an IP version of a user application.

11. The system of claim 9, wherein the first control tunnel comprises a first primary control tunnel set through a primary interface of the first mobile terminal and a first secondary control tunnel set through a secondary interface of the first mobile terminal, and the second control tunnel comprises a second primary control tunnel set through a primary interface of the second mobile terminal and a second secondary control tunnel set through a secondary interface of the second mobile terminal.

12. The system of claim 11, wherein the primary interface and the secondary interface of each of the first and second mobile terminals are determined based on at least one of user preference and signal strength.

13. The system of claim 9, wherein the first and second mobile terminals acquire each other's CoA from the mobility control apparatus, set a data tunnel between the first and second mobile terminals using the acquired CoAs, and exchange a data packet with each other through the data tunnel.
